(19) United States
(12) Patent Application Publication
(10) Pub. No.: US 2024/0235056 A1
(43) Pub. Date: Jul. 11, 2024

(54) ANTENNA ARRAYS

(71) Applicant: RADSEE TECHNOLOGIES LTD., HERZLIYA (IL)

(72) Inventors: Dani Raphaeli, Kfar Saba (IL); Gregory Lerner, Kfar Saba (IL)

(73) Assignee: RADSEE TECHNOLOGIES LTD., HERZLIYA (IL)

(21) Appl. No.: 18/554,196

(22) PCT Filed: Apr. 5, 2022
(86) PCT No.: PCT/IB2022/053184

§ 371 Date: Oct. 5, 2023

Related U.S. Application Data
(60) Provisional application No. 63/200,954, filed on Apr. 5, 2021.

(51) Int. Cl. H01Q 21/00; H01Q 21/06; H01Q 21/28

(52) U.S. Cl. CPC H01Q 21/0093; H01Q 21/064; H01Q 21/28

(57) ABSTRACT

A radio frequency (RF) radar that consists essentially of a radome; a single bulk in which RF antenna arrays and portions of waveguides are formed, wherein the waveguides lead to the RF antenna arrays; a printed circuit board (PCB) that supports an RF circuitry; lower-than-RF-frequency circuitry; and a back portion.

### BACKGROUND

PCT patent application WO2018/122849 illustrates a state of the art radar system which includes reception (RX) antenna arrays, transmission (TX) antenna arrays, TX/RX chips and additional component. The radar is very compact and highly efficient. Antennas of the array may be coupled to waveguides that are positions on both sides of a support element.

For example—a first array of TX waveguides (coupled to a first array of TX antennas) and a first array of RX waveguides (coupled to a first array of RX antennas) may be positioned on one side of a supporting element. A second array of TX waveguides (coupled to a second array of TX antennas) and a second array of RX waveguides (coupled to a second array of RX antennas) may be positioned on one side of the supporting element.

The waveguides may be formed by cavities and covers. All cavities can be formed in the supporting element and the covers are formed in other structural elements of the radar.

There is a growing need to reduce the complexity of the radar.

### SUMMARY

There may be provided a module of radar and/or a radar. The radar is a radio frequency (RF) radar but may operate in additional and/or other frequency bands. The module may include waveguides.

There may be provide an RF radar that may consist essentially of: a radome, a single bulk in which RF antenna arrays and portions of waveguides may be formed, wherein the waveguides may lead to the RF antenna arrays, a printed circuit board (PCB) that supports an RF circuitry, a lower-than-RF-frequency circuitry, and a back portion. Such as radar may be compact and simpler to construct in relation to radars that include multiple bulks.

The RF circuitry may include microstrips and waveguide to microstrip termination that couple the microstrips to the waveguides.

The waveguide to microstrip termination may be located in proximity to vertical to horizontal transitions of the waveguides.

The vertical to horizontal transitions of the waveguides may be followed by horizontal sections of the waveguides.

The horizontal sections of the waveguides may be followed by horizontal to vertical transitions of the waveguides.

The horizontal to vertical transitions may be followed by vertical sections of the waveguides.

The vertical sections of the waveguides may lead to the RF antenna arrays.

The portions of waveguides may include multi facets of the waveguides.

The transitions may include cavities formed within the PCB and a dielectric layer that terminates the cavities.

The RF antenna arrays may include a first transmission antenna array, a second transmission antenna array, a first reception antenna array, and a second reception antenna array.

The portions the waveguides may lead to the first transmission antenna array, the second transmission antenna array, the first reception antenna array, and the second reception antenna array, and wherein the portions of the waveguides may include bottom portions that may be formed in a bottom plane of the single bulk.

The complementary portions of the waveguides that may lead to the first transmission antenna array, the second transmission antenna array, the first reception antenna array, and the second reception antenna array may be formed on the PCB.

The complementary portions of the waveguides may include multiple facets of the waveguides.

The complementary portions of the waveguides may consist of a single facet of the waveguides.

The at least a majority of the waveguides may be oriented to each one of the RF antenna arrays.

The PCB also supports the lower-than-RF-frequency circuitry.

There may be provided a radio frequency (RF) radar that may include RF antenna arrays that may include a first transmission RF antenna array, a second transmission RF antenna array, a first reception RF antenna array, and a second reception RF antenna array; at least one structural element in which the RF antenna arrays and portions of waveguides may be formed, wherein the waveguides may lead to the RF antenna arrays; wherein the bottom portions of the waveguides may be formed at a single plane; a printed circuit board (PCB) that supports an RF circuitry, and a lower-than-RF-frequency circuitry.

The complementary portions of the waveguides that may lead to the first transmission antenna array, the second transmission antenna array, the first reception antenna array, and the second reception antenna array may be formed on the PCB.

The complementary portions of the waveguides may include multiple facets of the waveguides.

The complementary portions of the waveguides may consist of a single facet of the waveguides.

The at least a majority of the waveguides may be oriented to each one of the RF antenna arrays.

### BRIEF DESCRIPTION OF THE DRAWINGS

The subject matter regarded as the invention is particularly pointed out and distinctly claimed in the concluding portion of the specification. The invention, however, both as to organization and method of step, together with substrates, features, and advantages thereof, may best be understood by reference to the following detailed description when read with the accompanying drawings in which:

FIG. 1 is an example of some components of a radar;

FIG. 2 is an example of some components of a radar;

FIG. 3 is an example of some components of a radar;

FIG. 4 is an example of a radar;

FIG. 5 is an example of some components of a radar;

FIG. 6 is an example of some components of a radar;

FIG. 7 is an example of a radar; and

FIG. 8 is an example of some components of a radar.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Any reference in the specification to a method should be applied mutatis mutandis to a system capable of executing the method.

Any reference in the specification to a system should be applied mutatis mutandis to a method that may be executed by the system.

The assignment of the same reference numbers to various components may indicate that these components are similar to each other.

There may be provides an RF radar that may include a radome, a single bulk in which RF antenna arrays and portions of waveguides may be formed, a printed circuit board (PCB) that supports an RF circuitry, a lower-than-RF-frequency circuitry; and a back portion.

For simplicity of explanation is assumed that the radome is located at front of the radar. The side of the single bulk that faces the radome is referred to as a front side of the bulk. The side of the single bulk that faces the PCB is referred to as a back side of the single bulk. The side of the PCB that faces the single bulk is referred to as a front side of the PCB. The side of the PCB that faces the back portion of the radar (for example faces a heat sink) is referred to as a rear side of the PCB.

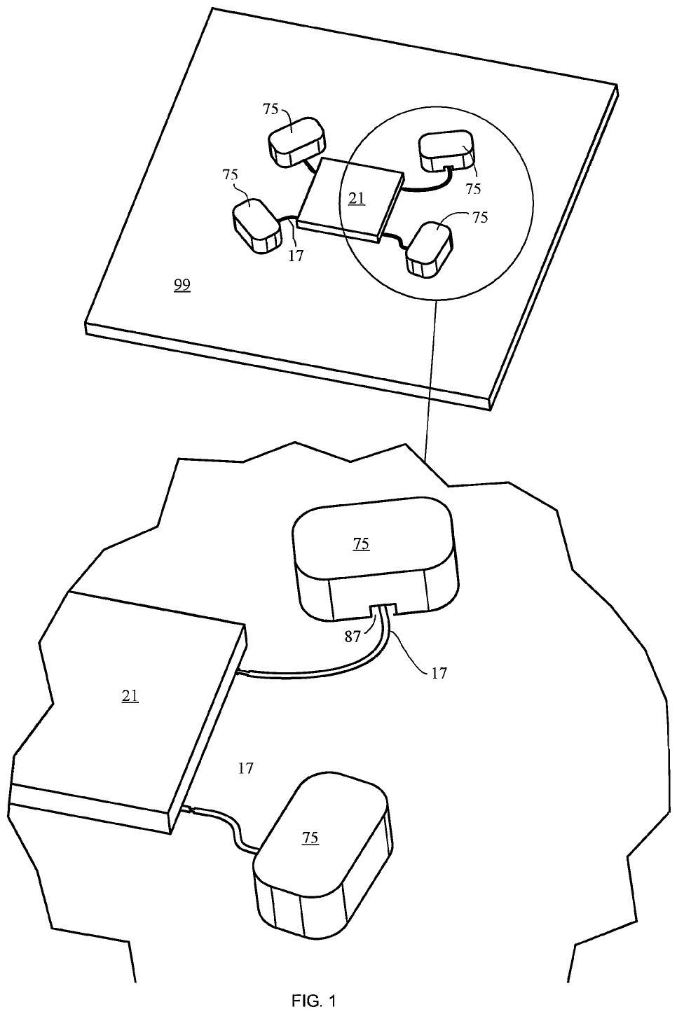

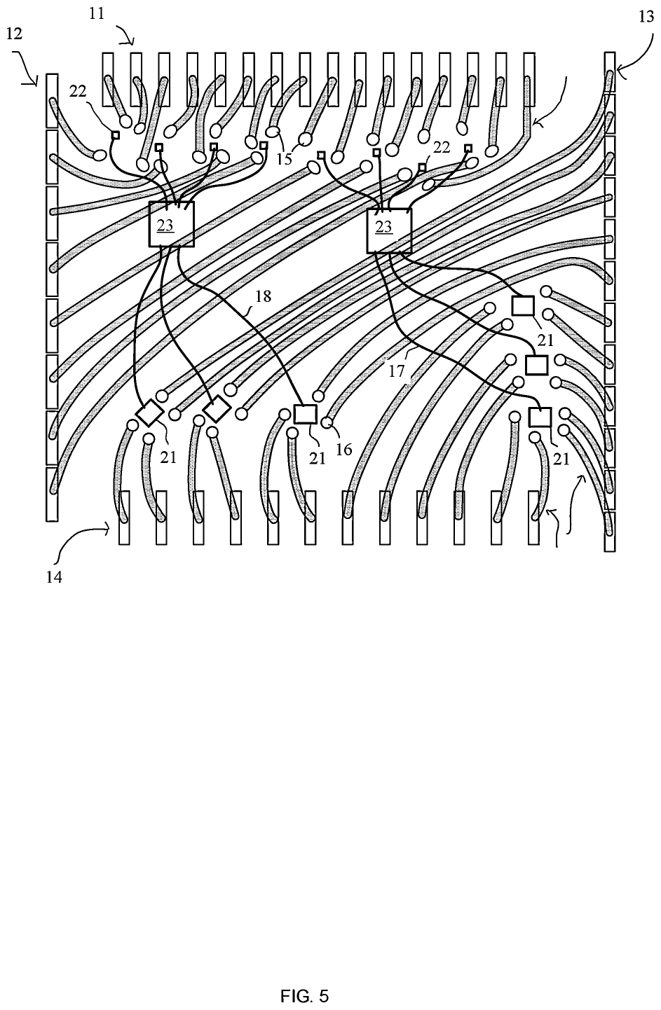

FIG. 1 illustrates the rear side 99 of the PCB and various RF components—including a switch (such as received switch—RX switch 21) that may be part of a reception path, may be a part of a transmission path or may be part of both. Microstrips 17 convey RF signals between the RX switch 21 and four waveguide to microstrip transitions 75. Any number of waveguide to microstrip transitions may be provided. The RX switch 21 (as well as transmission switches—denoted TX switch 22 in FIG. 5) are used for allocating multiple antennas per channel.

A microstrip 17 enters a waveguide to microstrip transition 75 via an opening 87 formed in the waveguide to microstrip transition 75.

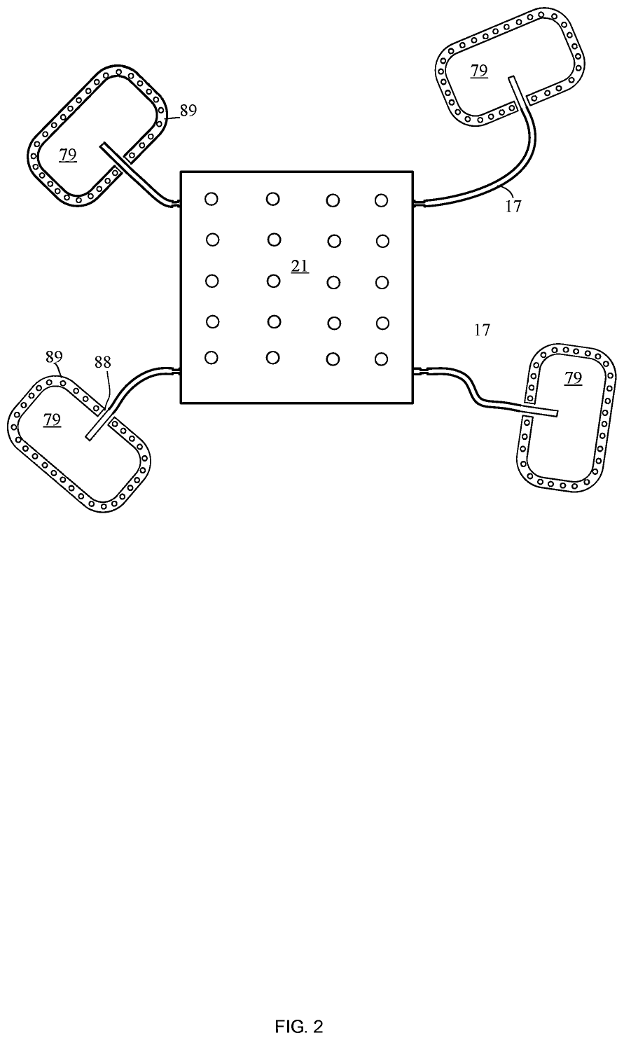

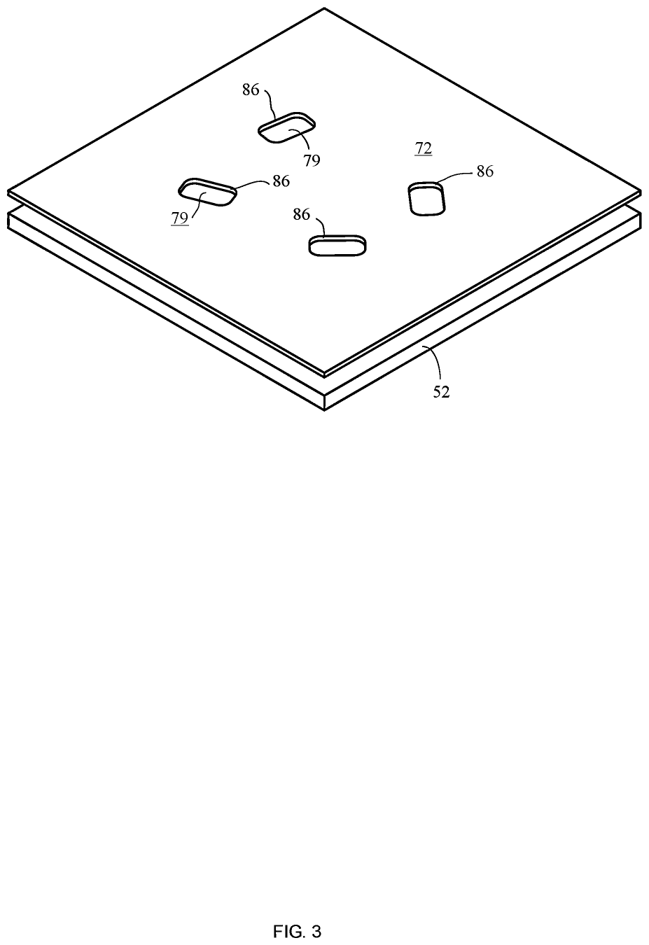

FIG. 2 illustrates a part of the rear side of the PCB without the waveguide to microstrip transitions. Sidewalls of the waveguide to microstrip transitions are positioned on a conductive frame 89 that has a gap 88- that corresponds to opening 87. A microstrip that enters through the opening gap 88 and opening 87 is mechanically supported by dielectric layer 79 that terminates cavities that pass through the PCB. The cavities are denoted 86 in FIG. 3. FIG. 3 also illustrates a conductive plate 52 that may form one or more covers to one or more waveguides. The covers may be example of complementary portions of the waveguides.

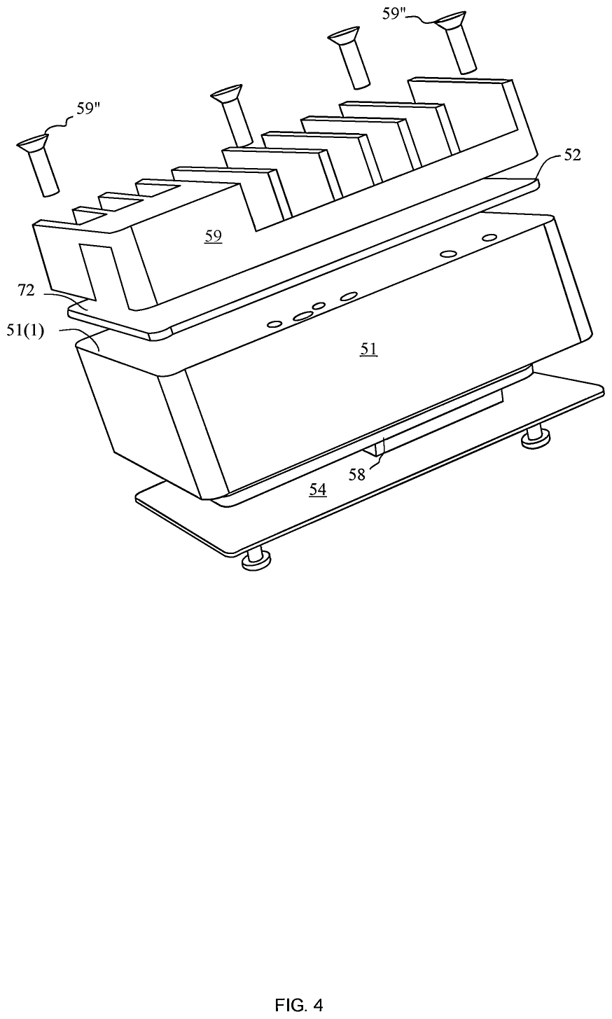

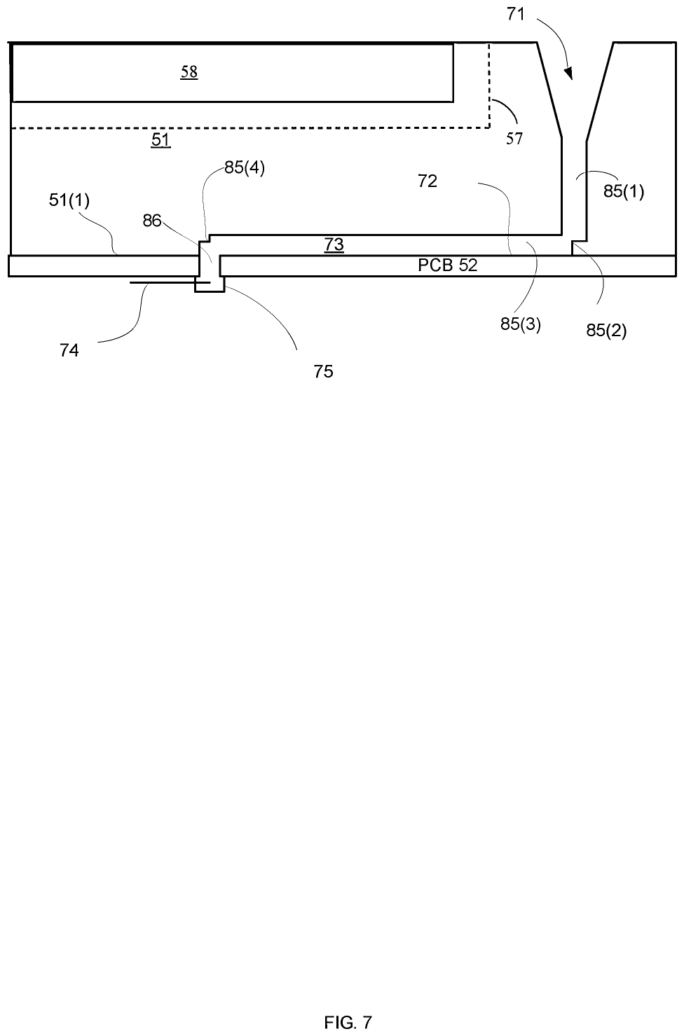

Referring to FIG. 4 - the radar 50 may include (i) a radome 54 that precedes RF antenna arrays, (ii) one or more structural elements such as single bulk 51 in which both RF antenna arrays and waveguides are at least partially formed, (iii) PCB 52, (iv) a back portion that may include one or more heatsinks 59, and (v) one or more additional components 58 such as a LIDAR, a camera, any other sensor, any electrical and/or optical and/or RF circuits that may be located within an inner space formed in the front side of the one or more structural elements—the inner space (denoted 57 in FIG. 7) is formed between the different antenna arrays. The heatsink may be fastened to the structural element 51 by fastening elements 59″. FIG. 4 is an exploded view of the radar and thus the one or more additional components 58 are located at least in part between the radome and the one or more structural elements.

The RF PCB may support monolithic microwave integrated circuits (MMIC) chips that operate in RF frequency and/or may support lower-that-RF frequency chips. The lower-than-RF frequency chips may operate at baseband and/or other lower frequency. Alternatively, the lower frequency chips may be located on another PCB (also referred to as digital PCB”).

FIG. 5 illustrates some layers of the radar.
a. First TX antenna array 11, a second TX antenna array 12, a first RX antenna array 13 and a second RX antenna array 14 pass through a part of the single bult and extend through the front side of the single bulk.
b. Various sets of waveguides are formed by cavities located within the rear side of the single bult and by complementary portions formed on the front side of the PCB.
c. Microstrips, waveguide to microstrip transitions, and RF circuitry (switches, RX/TX chips) are formed (at least mostly formed) on the rear side of the PCB.

The first TX antenna array 11, second TX antenna array 12, first RX antenna array 13 and second RX antenna array 14—located (when virtually looking at the front side of the single bulk) at a top facet, left facet, low facet and right facet of the support unit , respectively.

The first TX antenna array 11 is coupled via a first set of waveguides 31 to waveguides to TX waveguide to waveguide to microstrip transition 15. The second TX antenna array 12 is coupled via a second set of waveguides 32 to waveguides to TX waveguide to waveguide to microstrip transition 15.

The first RX antenna array 13 is coupled via a first set of waveguides 33 to waveguides to RX waveguide to waveguide to microstrip transition 16. The second RX antenna array 14 is coupled via a second set of waveguides 34 to waveguides to RX waveguide to waveguide to microstrip transition 16.

The RX waveguide to waveguide to microstrip transition 16 are coupled via microstrips (not shown) to RX switches 21.

The TX waveguide to waveguide to microstrip transition 15 are coupled via microstrips (not shown) to TX switches 22.

RX switches 21 are coupled via microstrips 18 to RX/TX chips 23.

TX switches 22 are coupled via microstrips 17 to RX/TX chips 23.

The waveguides do not cross each other—and may be located at a same plane—for example—their cavities are located at a rear plane of the single bult.

The module illustrated above may be configured to use RX and/TX antenna array subsets—as each antenna is coupled to a dedicated waveguide and multiple waveguides and/or microstrips coupled to waveguides are fed to RX and/or TX switches. A subset of antennas may include a consecutive set of antennas and/or non-consecutive set of antennas.

Any RF switch may be passive or active. For example—the TX switches may be active while the RX switches may be passive. Any RF switch may include signal amplification. A splitter with or without amplification and/or phase shifter can be used instead of any TX switch. A combiner with or without phase shifter and/or amplification can be used instead of any RX switch.

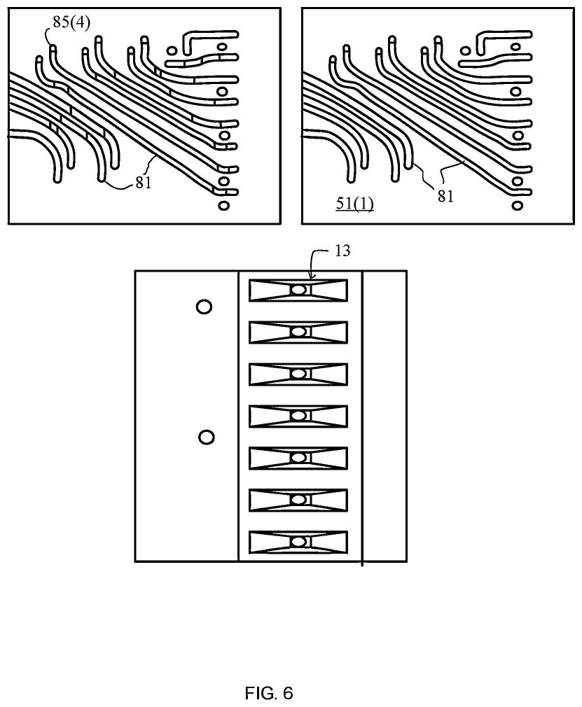

FIG. 6 illustrates a some cavities 81 formed in the back side 51(1) of the single bulk and also illustrated first RX antenna array 13 that extend from a frond side of the single bulk.

FIG. 7 illustrates cross section of a part of structural element 51 in which horn antenna 71 and waveguide 73 are formed. The part does not include a horn antenna of an opposite antenna array. The part illustrated (dashed line) a part of the inner space 57 formed at the front side of the single bulk 51—and may be of any depth—for example 10, 20, 30, 40, 50, 60, 70, 80 percent of the height of the single bulk.

The waveguide starts by a vertical to horizontal transition 85(4) (for example a knee formed by a part of a cavity formed in the single bulk), that is followed by a horizontal section 85(3) of the waveguide, that is followed by a horizontal to vertical transition 85(2), that is followed by a vertical section 85(1) of the waveguide. The vertical section 85(1) of the waveguide leads to the horn antenna 71.

The horizontal section may spang along a majority of the waveguide but any other relationship between the lengths of different sections of the waveguide may be provided.

The vertical to horizontal transition 85(4) is preceded by a cavity 86 that passes through the PCB that is preceded by a waveguide to microstrip transition 75. FIG. 7 also illustrates a microstrip 74.

Some of the waveguide (For example—the vertical sections—or any other section—immediately preceding or following the horn antenna) may be completely formed within the structural element and some other parts of the waveguide—for example—the horizontal section or any section that precedes the waveguide to microstrip transition) may be partially formed by the structural element.

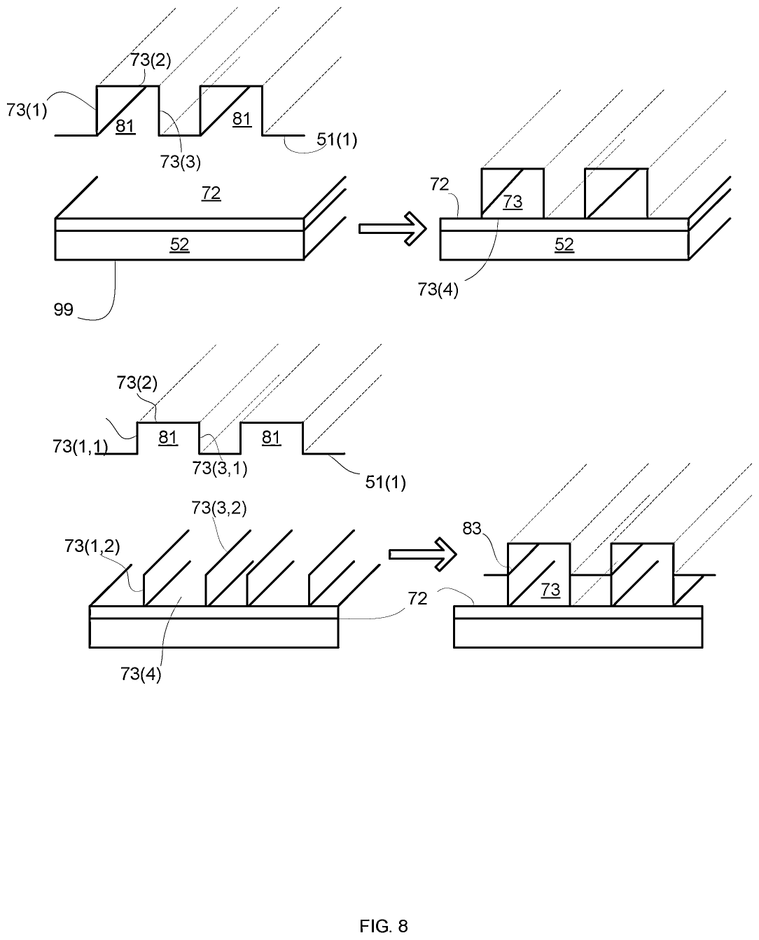

FIG. 8 illustrates two examples of forming waveguides.

According to a first example (shown at the upper part of FIG. 8) illustrates that three facets (73(1), 73(2) and 73(3)) of a rectangular waveguide are sidewalls of cavities 81 formed in the rear side of the bulk—and that fourth facet 73(4) if formed by a conductive plate 72 formed on the front side of the PCB 52. The rear side 99 of the PCB is also shown.

According to a second example (shown at the bottom part of FIG. 8)—one facet (73(2)) of the waveguide is formed by cavity 81, one other facet (73(4)) of the waveguide is formed by the conductive plate 72, a first parts (73(1,1) and 73(3,1)) of two additional facets are formed by cavity and second parts (73(1,2) and 73(3,2)) of the two additional facets are formed by conductive elements that extend from the PCB.

It has been found that forming the waveguides (for example by welding) is easier when using the second example—as the contact points (see welding line 83) are limited to the width of the segmented facets of the waveguide.

It should be noted that horn antennas (shown in various figures) may be replaced by another type of antenna—such as Printed microstrip antenna (PCB), Antenna on package. It has be found that the horn antenna provides good performance in terms of Wide bandwidth, High efficiency, High accuracy of production, matching between different elements, and Wide or narrow Field Of View by design.

The metal layer may be formed on the PCB in any manner. For example—may be done by soldering of the metal to the PCB. For this end, one method for easy fabrication uses mask for solder paste application. The use of flat surface of the metal makes this easy. The solder paste is applied on the metal rather than on the PCB since the PCB may already have some components assembled. Yet for another example—it may be done by applying conductive glue to the metal surface and then put in the oven as required by the glue manufacturer. Yet for a further example—it may be done using Thermally and Electrically Conductive Adhesive (TECA) film (see COOLSPAN® by Rogers). Such film is carved in the right shape and placed between the PCB and the metal and then pressed in the oven.

The cavities should be formed in an accurate manner—and positioning the cavities at one side (instead of two) reduces the manufacturing cost.

The orientation, shape, size position of any of the components mentioned above may change from those illustrated in any of the figures.

It should be noted that different waveguides may be formed by different (and even spaced apart) covers of complementary parts—and may not share the same conductive cover.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom ,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of step in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described steps are merely illustrative. The multiple may be combined into a single step, a single step may be distributed in additional steps and steps may be executed at least partially overlapping in time. Moreover, alternative embodiments may include multiple instances of a particular step , and the order of steps may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Any reference to the terms “including”, “comprising”, “having” may be applied mutatis mutandis to the term “consisting” and/or may be applied mutatis mutandis to the term “consisting essentially of”.

The phrase “may be X” indicates that condition X may be fulfilled. This phrase also suggests that condition X may not be fulfilled.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A radio frequency (RF) radar that consists essentially of:
a radome;
a single bulk in which RF antenna arrays and portions of waveguides are formed, wherein the waveguides lead to the RF antenna arrays;
a printed circuit board (PCB) that supports an RF circuitry;
lower-than-RF-frequency circuitry; and
a back portion.

2. The RF radar according to claim 1 wherein the RF circuitry comprise microstrips and waveguide to microstrip termination that couple the microstrips to the waveguides.

3. The RF radar according to claim 2 wherein the waveguide to microstrip termination are located in proximity to vertical to horizontal transitions of the waveguides.

4. The RF radar according to claim 3 wherein the vertical to horizontal transitions of the waveguides are followed by horizontal sections of the waveguides.

5. The RF radar according to claim 3 wherein the horizontal sections of the waveguides are followed by horizontal to vertical transitions of the waveguides.

6. The RF radar according to claim 5 wherein the horizontal to vertical transitions are followed by vertical sections of the waveguides.

7. The RF radar according to claim 5 wherein the vertical sections of the waveguides lead to the RF antenna arrays.

8. The RF radar according to claim 1 wherein the portions of waveguides comprise multi facets of the waveguides.

9. The RF radar according to claim 2 wherein the transitions comprises cavities formed within the PCB and a dielectric layer that terminates the cavities.

10. The RF radar according to claim 1 wherein the RF antenna arrays comprise a first transmission antenna array, a second transmission antenna array, a first reception antenna array, and a second reception antenna array.

11. The RF radar according to claim 9 wherein the portions the waveguides lead to the first transmission antenna array, the second transmission antenna array, the first reception antenna array, and the second reception antenna array, and wherein the portions of the waveguides comprise bottom portions that are formed in a rear plane of the single bulk.

12. The RF radar according to claim 10 wherein complementary portions of the waveguides that lead to the first transmission antenna array, the second transmission antenna array, the first reception antenna array, and the second reception antenna array are formed on the PCB.

13. The RF radar according to claim 10 wherein complementary portions of the waveguides comprises multiple facets of the waveguides.

14. The RF radar according to claim 10 wherein complementary portions of the waveguides consist of a single facet of the waveguides.

15. The RF radar according to claim 7 wherein at least a majority of the waveguides are oriented to each one of the RF antenna arrays.

16. The RF radar according to claim 1 wherein the PCB also supports the lower-than-RF-frequency circuitry.

17. A radio frequency (RF) radar that comprises of:
RF antenna arrays that comprise a first transmission RF antenna array, a second transmission RF antenna array, a first reception RF antenna array, and a second reception RF antenna array;
at least one structural element in which the RF antenna arrays and portions of waveguides are formed, wherein the waveguides lead to the RF antenna arrays;
wherein the bottom portions of the waveguides are formed at a single plane;
a printed circuit board (PCB) that supports an RF circuitry; and
a lower-than-RF-frequency circuitry.

18. The RF radar according to claim 17 wherein complementary portions of the waveguides that lead to the first transmission antenna array, the second transmission antenna array, the first reception antenna array, and the second reception antenna array are formed on the PCB.

19. The RF radar according to claim 18 wherein complementary portions of the waveguides comprises multiple facets of the waveguides.

20. The RF radar according to claim 18 wherein complementary portions of the waveguides consist of a single facet of the waveguides.

21. The RF radar according to claim 17 wherein at least a majority of the waveguides are oriented to each one of the RF antenna arrays.
